(19) United States
(12) Patent Application Publication
(10) Pub. No.: US 2026/0336424 A1
(43) Pub. Date: Oct. 29, 2026

(54) VEHICLE CONTROL APPARATUS AND VEHICLE CONTROL METHOD

(71) Applicant: SUBARU CORPORATION, Tokyo (JP)

(72) Inventor: Kazuya HOSOYAMA, Tokyo (JP)

(21) Appl. No.: 19/104,023

(22) PCT Filed: Aug. 25, 2023
(86) PCT No.: PCT/JP2023/030689

§ 371 Date: Feb. 14, 2025

(51) Int. Cl. B60L 15/20

(52) U.S. Cl. CPC B60L 15/20; B60L 2240/16; B60L 2240/423; B60L 2240/48

(57) ABSTRACT

A vehicle control apparatus according to an aspect of the disclosure is an apparatus configured to control a vehicle that travels by driving a motor. The vehicle control apparatus includes a control unit configured to acquire target torque by adding, to requested torque corresponding to an acceleration rate request, fluctuation torque that fluctuates cyclically, and control torque of the motor, based on the acquired target torque. The control unit is configured to, when the vehicle is in a transient state, vary a gain of the fluctuation torque depending on a gear stage. The transient state is different from a steady state in which an acceleration rate of the vehicle and an angular velocity of the vehicle are each less than or equal to a predetermined value.

### TECHNICAL FIELD

The disclosure relates to a vehicle control apparatus to be mounted on a vehicle and to a vehicle control method to be executed in the vehicle control apparatus.

### BACKGROUND ART

Various techniques for more safely operating a vehicle have been proposed (for example, see Patent Literatures 1 and 2).

### CITATION LIST

### Patent Literature

Patent Literature 1: Japanese Unexamined Patent Application Publication No. 2017-055618

Patent Literature 2: Japanese Unexamined Patent Application Publication No. 2011-205799

### SUMMARY OF INVENTION

An aspect of the disclosure provides a vehicle control apparatus configured to control a vehicle that travels by driving a motor. The vehicle control apparatus includes a control unit configured to acquire target torque by adding, to requested torque corresponding to an acceleration rate request, fluctuation torque that fluctuates cyclically, and control torque of the motor, based on the acquired target torque. The control unit is configured to, when the vehicle is in a transient state, vary a gain of the fluctuation torque depending on a gear stage. The transient state is different from a steady state in which an acceleration rate of the vehicle and an angular velocity of the vehicle are each less than or equal to a predetermined value.

An aspect of the disclosure provides a vehicle control method configured to control a vehicle that travels by driving a motor. The vehicle control method includes the following two acts.
(A) Acquiring target torque by adding, to requested torque corresponding to an acceleration rate request, fluctuation torque that fluctuates cyclically, and controlling torque of the motor, based on the acquired target torque.
(B) Varying a gain of the fluctuation torque depending on a gear stage when the vehicle is in a transient state, the transient state being different from a steady state in which an acceleration rate of the vehicle and an angular velocity of the vehicle are each less than or equal to a predetermined value.

### BRIEF DESCRIPTION OF DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating an example of functional blocks of a vehicle including a vehicle control apparatus according to one embodiment of the disclosure.

FIG. 2 Part (A) of FIG. 2 is a chart illustrating an example of a waveform of requested torque (regenerative torque). Part (B) of FIG. 2 is a chart illustrating an example of a waveform of fluctuation torque. Part (C) of FIG. 2 is a chart illustrating an example of a waveform of target torque.

FIG. 3 Part (A) of FIG. 3 is a chart illustrating an example of a waveform of the requested torque (power running torque). Part (B) of FIG. 3 is a chart illustrating an example of a waveform of the fluctuation torque. Part (C) of FIG. 3 is a chart illustrating an example of a waveform of the target torque.

FIG. 4 is an explanatory chart of an example of a procedure for acquiring the fluctuation torque in a travel controller of FIG. 1.

FIG. 5 is an explanatory chart of an example of a procedure for setting a gain of the fluctuation torque acquired by the procedure of FIG. 4 and an example of a procedure for acquiring the target torque.

FIG. 6 is a diagram illustrating an example of how a vehicle passes through a corner.

FIG. 7 is a chart illustrating an example of the waveform of the target torque obtained when the vehicle passes through the corner of FIG. 6.

### MODES FOR CARRYING OUT THE INVENTION

A vehicle that travels by driving a motor has a motor output that is smoother than an engine output. This provides a smooth operation feeling in all travel states including, for example, straight traveling, travel lane changing, and curve traveling. While obtaining such an operation feeling, however, a driver has difficulties in grasping a grip state between wheels and a road surface and having a sense of security and steering feel upon turning (e.g., cornering, turning right or left at an intersection, or making a lane change). It is desirable to provide a vehicle control apparatus and a vehicle control method that each allow a driver to have a sense of security and steering feel upon turning.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### 1. Embodiment

### [Configuration Example]

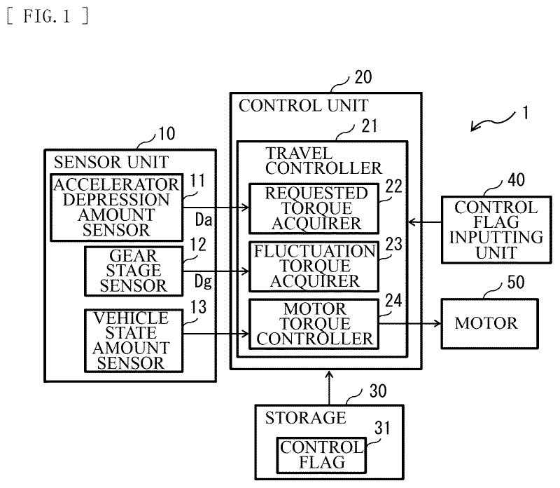

FIG. 1 illustrates a schematic configuration example of a vehicle 1 including a control unit 20 according to one embodiment of the disclosure. The control unit 20 corresponds to a specific example of a “control unit” according to the disclosure. The vehicle 1 is configured to travel by driving a motor. As illustrated in FIG. 1, the vehicle 1 includes, for example, a sensor unit 10, the control unit 20, a storage 30, a control flag inputting member 40, and a motor 50.

The sensor unit 10 includes various sensors mounted on the vehicle 1. As illustrated in FIG. 1, the sensor unit 10 includes, for example, an accelerator operation amount sensor 11, a gear stage sensor 12, and a vehicle state amount sensor 13. The sensor unit 10 may include any other sensor than those described above.

The accelerator operation amount sensor 11 is configured to detect an accelerator operation amount, based on a depression amount of an accelerator pedal. The accelerator operation amount sensor 11 is configured to output data on the detected accelerator operation amount (accelerator operation amount data Da) to the control unit 20. When the accelerator operation amount data Da is zero, the control unit 20 is configured to take an acceleration rate request made by the driver as a deceleration request. When the accelerator operation amount data Da is more than zero, the control unit 20 is configured to take the acceleration rate request made by the driver as an acceleration request.

The gear stage sensor 12 is a sensor configured to detect a current gear stage. The gear stage sensor 12 may be, for example, an input position detection sensor configured to detect the current gear stage by detecting an input position of a shift lever. The gear stage sensor 12 may be, for example, a signal detection sensor configured to detect the current gear stage by detecting a signal outputted in response to an operation of a paddle shift. The gear stage sensor 12 is configured to output data on the detected gear stage (gear stage data Dg) to the control unit 20.

For example, for a first gear stage, the gear stage sensor 12 outputs D1 as the gear stage data Dg. For example, for a second gear stage, the gear stage sensor 12 outputs D2 as the gear stage data Dg. For example, for a third gear stage, the gear stage sensor 12 outputs D3 as the gear stage data Dg. For example, for a fourth gear stage, the gear stage sensor 12 outputs D4 as the gear stage data Dg.

The vehicle state amount sensor 13 is configured to detect a vehicle state amount that is information indicating a state of the vehicle 1. The vehicle state amount sensor 13 is configured to output time-series data on the detected vehicle state amount (vehicle state amount data) to the control unit 20. The vehicle state amount sensor 13 includes, for example, a vehicle speed sensor, an acceleration rate sensor, an angular velocity sensor, a steering wheel angle sensor, and a steering torque sensor as sensors each configured to detect the vehicle state amount.

The vehicle speed sensor is configured to detect a speed of the vehicle 1 (a vehicle speed). The vehicle speed sensor is configured to output time-series data on the detected vehicle speed (vehicle speed data) to the control unit 20. The acceleration rate sensor is configured to detect an acceleration rate applied to the vehicle 1. The acceleration rate sensor is configured to output, to the control unit 20, time-series data on the detected acceleration rates in three directions (a longitudinal acceleration rate, a lateral acceleration rate, and a vertical acceleration rate) (acceleration rate data). The angular velocity sensor is configured to detect an angular velocity of the vehicle 1. The angular velocity sensor is configured to output, to the control unit 20, time-series data on the three detected angular velocities (a yaw angular velocity, a roll angular velocity, and a pitch angular velocity) (angular velocity data).

The steering wheel angle sensor is configured to detect a steering wheel angle (a steering angle) of a steering wheel of the vehicle 1. The steering wheel angle sensor is configured to output time-series data on the detected steering angle (steering angle data) to the control unit 20. The steering torque sensor is configured to detect steering torque generated by a steering operation performed by the driver. The steering torque sensor is configured to output time-series data on the detected steering torque (steering torque data) to the control unit 20.

The control unit 20 is configured to control the entire vehicle 1. The control unit 20 is, for example, a so-called electronic control unit (ECU), and includes, for example, one or more processors and one or more memories. The control unit 20 may include, for example, a central processing unit (CPU). In this case, the control unit 20 may be configured to control the entire vehicle 1 by, for example, executing a program stored in the storage 30.

The control unit 20 is configured to control the vehicle 1 that travels by driving the motor. As illustrated in FIG. 1, the control unit 20 includes, for example, a travel controller 21. The travel controller 21 is configured to control traveling of the vehicle 1 (e.g., torque of the motor 50). As illustrated in FIG. 1, the travel controller 21 includes, for example, a requested torque acquirer 22, a fluctuation torque acquirer 23, and a motor torque controller 24.

The requested torque acquirer 22 is configured to acquire requested torque Tr corresponding to the acceleration rate request. The acceleration rate request includes depression of the accelerator pedal or a variation in the depression amount of the accelerator pedal, and the number of gear stages or a change in gear stage. The acceleration rate request includes, for example, the accelerator operation amount data Da and the gear stage data Dg. The requested torque acquirer 22 is configured to acquire a torque amount (the requested torque Tr) to be generated by the motor 50, based on, for example, the accelerator operation amount data Da and the gear stage data Dg. The acceleration rate request may be made by the driver during manual driving, or may be made by the travel controller 21 during automated driving.

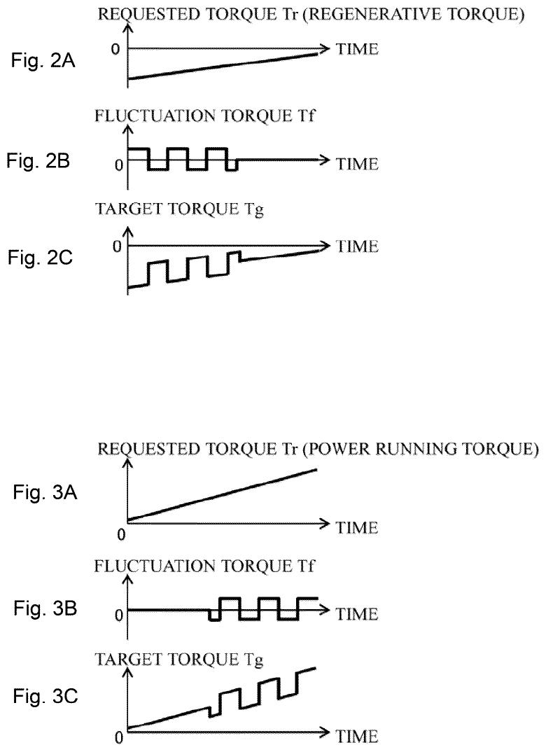

Part (A) of FIG. 2 illustrates an example of a temporal change in the requested torque Tr (regenerative torque) obtained when the driver is lifting his/her foot off the accelerator pedal during traveling of the vehicle 1. Illustrated in Part (A) of FIG. 2 is an example of how the vehicle 1 decelerates with time and how the requested torque Tr (the regenerative torque) decreases with time accordingly. For example, when the accelerator operation amount data Da is zero, the requested torque acquirer 22 is configured to acquire the requested torque Tr (the regenerative torque) to be generated by the motor 50, based on the gear stage data Dg.

Part (A) of FIG. 3 illustrates an example of a temporal change in the requested torque Tr (power running torque) obtained when the driver is depressing the accelerator pedal with time. Illustrated in Part (A) of FIG. 3 is an example of how the vehicle 1 accelerates with time and how the requested torque Tr (the power running torque) increases with time accordingly. The requested torque acquirer 22 is configured to acquire the requested torque Tr (the power running torque) to be generated by the motor 50, based on, for example, the accelerator operation amount data Da and the gear stage data Dg.

The fluctuation torque acquirer 23 is configured to acquire the fluctuation torque Tf (Part (B) of FIG. 2 and Part (B) of FIG. 3) that fluctuates cyclically. Part (B) of FIG. 2 and Part (B) of FIG. 3 each illustrate an example of a temporal change in the fluctuation torque Tf. The fluctuation torque Tf is set to allow the driver to have the sense of security and the steering feel upon turning (e.g., cornering, turning right or left at an intersection, or making a lane change) by intentionally changing a behavior of the vehicle 1.

A fluctuation range of the fluctuation torque Tf has, for example, about 10% of a magnitude of the requested torque Tr. A frequency of the fluctuation torque Tf is, for example, 17 Hz, 20 Hz, or 24 Hz. A waveform of the fluctuation torque Tf is, for example, a square waveform or a sine waveform. The fluctuation range, the frequency, and the waveform of the fluctuation torque Tf are not limited to those described above. For example, the fluctuation torque acquirer 23 may be configured to vary one or more of the fluctuation range, the frequency, and the waveform of the fluctuation torque Tf depending on the magnitude of the requested torque Tr. For example, the fluctuation torque acquirer 23 may be configured to cause one or more of the fluctuation range, the frequency, and the waveform of the fluctuation torque Tf to be constant regardless of the magnitude of the requested torque Tr.

When receiving a gain G of the fluctuation torque Tf from the motor torque controller 24, the fluctuation torque acquirer 23 is configured to correct the fluctuation torque Tf, based on the received gain G. For example, the fluctuation torque acquirer 23 is configured to acquire new fluctuation torque (Tf×G) by multiplying the fluctuation torque Tf by the gain G. The gain G will be described in detail later.

The motor torque controller 24 is configured to acquire the target torque Tg (Part (C) of FIG. 2 and Part (C) of FIG. 3) by adding the fluctuation torque (Tf or Tf×G) to the requested torque Tr, and control the torque of the motor 50, based on the acquired target torque Tg. Part (C) of FIG. 2 and Part (C) of FIG. 3 each illustrate an example of a temporal change in the target torque Tg.

The motor torque controller 24 is configured to determine whether the vehicle 1 is in a steady state or a transient state, based on, for example, the vehicle state amount data (the acceleration rate data and the angular velocity data) obtained from the vehicle state amount sensor 13. The term “steady state” refers to a state in which the acceleration rate data and the angular velocity data are each less than or equal to a predetermined value (threshold). The term “steady state” encompasses uniform linear traveling and a state in which the vehicle 1 is traveling with a steering angle of 0° or a very small steering angle at a speed within a range that allows for the uniform linear traveling. The “transient state” refers to a state different from the “steady state”. The term “transient state” encompasses turning (e.g., cornering, turning right or left at an intersection, and making a lane change) and steady circular turning. When the steering angle is more than a predetermined value (threshold), the vehicle 1 is determined to be turning, i.e., in the “transient state”.

For example, the motor torque controller 24 is configured to vary the gain G of the fluctuation torque Tf depending on the gear stage. For example, when the vehicle 1 is in the transient state, the motor torque controller 24 is configured to vary the gain G of the fluctuation torque Tf depending on the gear stage. The motor torque controller 24 is configured to set the gain G of the fluctuation torque Tf, based on, for example, the gear stage data Dg obtained by the gear stage sensor 12.

In one example where the requested torque Tr in the transient state is the regenerative torque, the motor torque controller 24 is configured to set the gain G of the fluctuation torque Tf in the first gear stage to G1 (a first gain). In the example where the requested torque Tr in the transient state is the regenerative torque, the motor torque controller 24 is configured to set the gain G of the fluctuation torque Tf in the second gear stage to G2 (the first gain). In the example where the requested torque Tr in the transient state is the regenerative torque, the motor torque controller 24 is configured to set the gain G of the fluctuation torque Tf in the third gear stage to G3 (the first gain). In the example where the requested torque Tr in the transient state is the regenerative torque, the motor torque controller 24 is configured to set the gain G of the fluctuation torque Tf in the fourth gear stage to G4 (the first gain). Here, a magnitude of the gain G increases as the gear stage (a gear ratio) decreases. For example, G1>G2>G3>G4 is satisfied.

In one example where the requested torque Tr in the transient state is the power running torque, the motor torque controller 24 is configured to set the gain G of the fluctuation torque Tf in the first gear stage to G5 (a second gain) that is less than G1 (the first gain). In the example where the requested torque Tr in the transient state is the power running torque, the motor torque controller 24 is configured to set the gain G of the fluctuation torque Tf in the second gear stage to G6 (the second gain) that is less than G2 (the first gain). In the example where the requested torque Tr in the transient state is the power running torque, the motor torque controller 24 is configured to set the gain G of the fluctuation torque Tf in the third gear stage to G7 (the second gain) that is less than G3 (the first gain). In the example where the requested torque Tr in the transient state is the power running torque, the motor torque controller 24 is configured to set the gain G of the fluctuation torque Tf in the fourth gear stage to G8 (the second gain) that is less than G4 (the first gain). Here, the magnitude of the gain G increases as the gear stage (the gear ratio) decreases. For example, G5>G6>G7>G8 is satisfied.

The motor torque controller 24 is configured to determine whether it is necessary to add the fluctuation torque Tf to the requested torque Tr, based on, for example, a control flag 31 to be described later. For example, when the control flag 31 indicates a torque fluctuation control mode, the motor torque controller 24 is configured to acquire the target torque Tg by adding the fluctuation torque Tf to the requested torque Tr. The term “torque fluctuation control mode” refers to a mode that performs torque control that involves vibration of the target torque Tg at a low frequency (e.g., 17 Hz, 20 Hz, or 24 Hz). For example, when the control flag 31 indicates a normal mode, the motor torque controller 24 is configured to set the requested torque Tr to the target torque Tg. The term “normal mode” refers to a mode that performs torque control in accordance with the requested torque Tr, without involving the vibration of the target torque Tg at a low frequency.

The storage 30 holds, for example, the control flag 31 received from the control flag inputting member 40. The storage 30 may hold, for example, a program to be executed by the control unit 20. The program is a program that causes the control unit 20 to execute a series of steps for controlling the entire vehicle 1. The storage 30 includes, for example, a random-access memory (RAM), a read-only memory (ROM), or an auxiliary storage device (such as a hard disk).

The control flag inputting member 40 is configured to receive an input of the control flag 31 from the driver. The control flag inputting member 40 is, for example, a paddle shift attached to the steering wheel. For example, when the driver simultaneously holds down left and right paddle shifts, the control flag inputting member 40 is configured to store a control flag 31 of “1” in the storage 30. For example, when the driver simultaneously holds down the left and right shifts again after the control flag 31 of “1” has been stored in the storage 30 in the previous operation, the control flag inputting member 40 is configured to store a control flag 31 of “0” in the storage 30. For example, when the driver simultaneously holds down the left and right paddle shifts again after the control flag 31 of “0” has been stored in the storage 30 in the previous operation, the control flag inputting member 40 is configured to store a control flag of “1” in the storage 30.

The control flag 31 of “1” indicates, for example, the torque fluctuation control mode. The control flag 31 of “0” indicates, for example, the normal mode in which cyclic torque fluctuation control is not performed. Note that a possible value of the control flag 31 is not limited to those described above.

The motor 50 is configured to drive steered wheels of the vehicle 1. The motor 50 is configured to drive the steered wheels of the vehicle 1 in accordance with the target torque Tg received from the motor torque controller 24. Note that the term “steering wheels” used herein refers to front wheels, rear wheels, or both. Alternatively, one motor 50 may be provided to the front wheels, and another motor 50 may be provided to the rear wheels. In this case, the travel controller 21 may be configured to control the motor 50 for the front wheels and the other motor 50 for the rear wheels in a common way. Further, the travel controller 21 may be configured to control the motor 50 for the front wheels and the other motor 50 for the rear wheels independently from each other.

### Operation

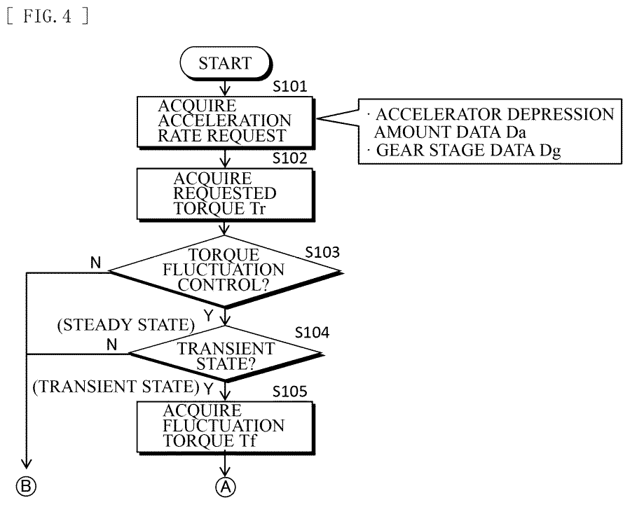

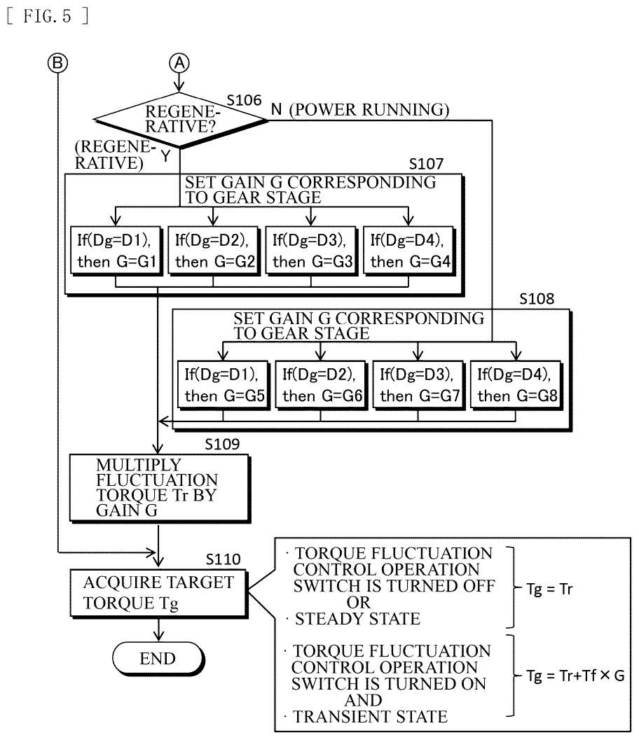

Next, an operation of the travel controller 21 will be described with reference to FIG. 4. FIG. 4 is an explanatory chart of an example of a procedure for acquiring the fluctuation torque Tf. FIG. 5 is an explanatory chart of an example of a procedure for setting the gain G of the fluctuation torque Tf acquired in the procedure of FIG. 4 and an example of a procedure for acquiring the target torque Tg.

The travel controller 21 acquires the acceleration rate request from the accelerator operation amount sensor 11 and the gear stage sensor 12 (step S101). For example, the travel controller 21 acquires the accelerator operation amount data Da and the gear stage data Dg respectively from the accelerator operation amount sensor 11 and the gear stage sensor 12. Thereafter, the travel controller 21 acquires the requested torque Tr corresponding to the acquired acceleration rate request (the accelerator operation amount data Da and the gear stage data Dg) (step S102). For example, when the accelerator operation amount data Da is zero, the travel controller 21 acquires the regenerative torque as the requested torque Tr. For example, when the accelerator operation amount data Da is more than zero, the travel controller 21 acquires the power running torque as the requested torque Tr.

Thereafter, if the control flag 31 received from the control flag inputting member 40 indicates the torque fluctuation control mode (step S103: Y), the travel controller 21 determines whether the vehicle 1 is in the transient state (step S104). If the vehicle 1 is in the transient state (step S104: Y), the travel controller 21 acquires the fluctuation torque Tf that fluctuates cyclically (step S105). If the control flag 31 received from the control flag inputting member 40 indicates the normal mode (step S103: N) or if the vehicle 1 is not in the transient state and is in the steady state (step S104: N), the travel controller 21 sets the requested torque Tr to the target torque Tg (step S110).

Thereafter, when having acquired the fluctuation torque Tf in step S105, the travel controller 21 determines whether the requested torque Tr in the transient state is the regenerative torque (step S106). If the requested torque Tr in the transient state is the regenerative torque (step S106: Y), the travel controller 21 sets the gain G (e.g., G1, G2, G3, or G4) corresponding to the gear stage (step S107). If the requested torque Tr in the transient state is not the regenerative torque and is the power running torque (step S106: N), the travel controller 21 sets the gain G (e.g., G5, G6, G7, or G8) corresponding to the gear stage (step S108).

When having set the gain G in step S107 or step S108, the travel controller 21 acquires new fluctuation torque (Tf×G) by multiplying the fluctuation torque Tf by the gain G (step S109). Thereafter, the travel controller 21 acquires the target torque Tg by adding the fluctuation torque (Tf×G) to the requested torque Tr (step S110). In this way, the target torque Tg is acquired.

Thereafter, the travel controller 21 acquires the target torque Tg by adding fluctuation torque (Tf×Ga or Tf×Gb) to the requested torque Tr, and controls the torque of the motor 50, based on the acquired target torque Tg. In this way, the torque of the motor 50 is controlled.

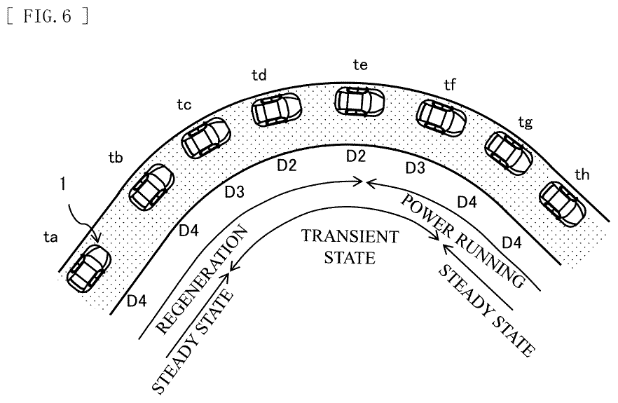

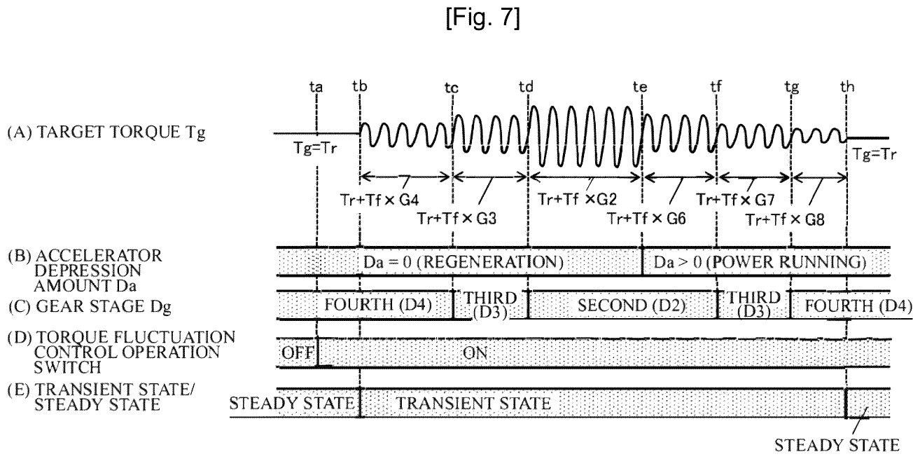

Next, the operation of the travel controller 21 will be described with reference to FIGS. 6 and 7.

FIG. 6 illustrates an example of how the vehicle 1 passes through a corner. Part (A) of FIG. 7 illustrates an example of a waveform of the target torque Tg obtained when the vehicle 1 passes through the corner. Part (B) of FIG. 7 illustrates an example of a temporal change in the accelerator operation amount data Da obtained when the vehicle 1 passes through the corner. Part (C) of FIG. 7 illustrates an example of a temporal change in the gear stage data Dg obtained when the vehicle 1 passes through the corner. Part (D) of FIG. 7 illustrates an example of a temporal change in an on and off state of a torque fluctuation control operation switch obtained when the vehicle 1 passes through the corner. On and off of the torque fluctuation control operation switch respectively correspond to “1” and “0” of the control flag 31 described above. Part (E) of FIG. 7 illustrates an example of a temporal change in a state of the vehicle 1 obtained when the vehicle 1 passes through the corner. Illustrated in Part (E) of FIG. 7 is an exemplary state of the vehicle 1 that is the steady state or transient state described above.

First, the vehicle 1 is in the steady state with the driver's foot being off the accelerator pedal in the fourth gear stage (D4), and the torque fluctuation control operation switch is turned off. In this case, at time ta, the driver inputs the control flag 31 indicating the torque fluctuation control mode, with the control flag inputting member 40. When the vehicle 1 in this state enters the corner at time tb, the travel controller 21 detects that the vehicle 1 has shifted to the transient state. This causes the travel controller 21 to multiply the fluctuation torque Tf by the gain G4, and start controlling the regenerative torque of the motor 50, based on the target torque Tg (=Tr+Tf×G4) whose amplitude fluctuates.

Thereafter, while the vehicle 1 is turning the corner, the gear stage is changed to the third gear stage (D3) at time tc, the second gear stage (D2) at time td, the third gear stage (D3) at time tf, and the fourth gear stage (D4) at time tg by an operation performed by the driver on the shift lever or the paddle shift or automated control performed by the travel controller 21. Further, the driver depresses the accelerator pedal at time te when the vehicle 1 has entered a second half (an exit phase) of the corner. While the driver is lifting his/her foot off the accelerator pedal, the travel controller 21 changes the target torque Tg to the regenerative torque (Tr+Tf×G3) at time tc and the regenerative torque (Tr+Tf×G2) at time td. Further, when the driver is depressing the accelerator pedal, the travel controller 21 changes the target torque Tg to the power running torque (Tr+Tf×G6) at time te, the power running torque (Tr+Tf×G7) at time tf, and the power running torque (Tr+Tf×G8) at time tg. Consequently, when the vehicle 1 is in a first half of (at the time of entry into) the corner, the amplitude in cyclic vibration of the target torque Tg increases as the gear stage decreases, as illustrated in FIG. 7, for example. Furthermore, when the vehicle 1 is in the second half of (at the time of exiting) the corner, the amplitude in the cyclic vibration of the target torque Tg decreases as the gear stage increases, as illustrated in FIG. 7, for example.

Next, an effect of the control unit 20 according to one embodiment of the disclosure will be described.

According to the present embodiment, in the vehicle 1 that travels by driving the motor, the target torque Tg is acquired by adding, to the requested torque Tr corresponding to the acceleration rate request, the fluctuation torque Tf that fluctuates cyclically, and the torque of the motor 50 is controlled based on the acquired target torque Tg. When the vehicle 1 is in the transient state, the gain G of the fluctuation torque Tf is varied depending on the gear stage. Such a configuration allows the driver to easily grasp the grip state between the wheels and the road surface and have the sense of security and the steering feel upon, for example, turning (e.g., cornering, turning right or left at an intersection, or making a lane change). In the present embodiment, the improvement in driver information as described above allows the driver to have the sense of security and the steering feel. Further, moderate vibration allows the driver to have a driving feeling similar to that in driving of an engine vehicle.

According to the present embodiment, the determination as to whether the vehicle 1 is in the steady state or the transient state is made based on the acceleration rate data and the angular velocity data that are obtained by the vehicle state amount sensor 13. Further, the gain G of the fluctuation torque Tf is set based on the gear stage data Dg obtained by the gear stage sensor 12. Such a configuration allows the driver to easily grasp the grip state between the wheels and the road surface and have the sense of security and the steering feel upon turning (e.g., cornering, turning right or left at an intersection, or making a lane change), for example. In the present embodiment, the improvement in the driver information as described above allows the driver to have the sense of security and the steering feel. Further, the moderate vibration allows the driver to have the driving feeling similar to that in driving of the engine vehicle.

According to the present embodiment, the gain G5 of the fluctuation torque Tf set in the first gear stage when the requested torque Tr in the transient state is the power running torque is less than the gain G1 of the fluctuation torque Tf set in the first gear stage when the requested torque Tr in the transient state is the regenerative torque. The gain G6 of the fluctuation torque Tf set in the second gear stage when the requested torque Tr in the transient state is the power running torque is less than the gain G2 of the fluctuation torque Tf set in the second gear stage when the requested torque Tr in the transient state is the regenerative torque. The gain G7 of the fluctuation torque Tf set in the third gear stage when the requested torque Tr in the transient state is the power running torque is less than the gain G3 of the fluctuation torque Tf set in the third gear stage when the requested torque Tr in the transient state is the regenerative torque. The gain G8 of the fluctuation torque Tf set in the fourth gear stage when the requested torque Tr in the transient state is the power running torque is less than the gain G4 of the fluctuation torque Tf set in the fourth gear stage when the requested torque Tr in the transient state is the regenerative torque. Such a configuration makes it possible to achieve smooth acceleration while allowing the driver to have the sense of security and the steering feel in the second half (the exit phase) of turning (e.g., cornering, turning right or left at an intersection, or making a lane change).

According to the present embodiment, the determination as to whether it is necessary to add the fluctuation torque Tf to the requested torque Tr is made based on the control flag 31 inputted via the control flag inputting member 40 provided in the vehicle 1. If the control flag 31 indicates the torque fluctuation control mode, the target torque Tg is acquired by adding the fluctuation torque Tf to the requested torque Tr. Such a configuration makes it possible to provide a driving feeling responding to a demand of the driver.

### <2. Modification Example>

Although the disclosure has been described above with reference to the embodiment, the disclosure is not limited to the embodiment, and various modifications may be made.

According to the foregoing embodiment, one motor 50 may be provided to the front wheels, and another motor 50 may be provided to the rear wheels. In this case, the travel controller 21 may be configured to control the motor 50 for the front wheels and the other motor 50 for the rear wheels independently from each other. Further, the motor torque controller 24 may be configured to control torque of the front wheels and torque of the rear wheels separately from each other.

In this case, the motor torque controller 24 enables an appropriate adjustment of the driving feeling obtained from the front wheels and the driving feeling obtained from the rear wheels by separately varying the gain G of the fluctuation torque Tf of the front wheels and the gain G of the fluctuation torque Tf of the rear wheels. This allows the driver to have a sense of security and steering feel more appropriately.

The effects described herein are merely exemplary, and the effects of the disclosure are not limited to the effects described herein. Accordingly, the disclosure may achieve other effects.

The disclosure further may take the following aspects.

(1)

A vehicle control apparatus configured to control a vehicle that travels by driving a motor, the vehicle control apparatus including
a control unit configured to acquire target torque by adding, to requested torque corresponding to an acceleration rate request, fluctuation torque that fluctuates cyclically, and control torque of the motor, based on the acquired target torque, in which
when the vehicle is in a transient state, the control unit is configured to vary a gain of the fluctuation torque depending on a gear stage, the transient state being different from a steady state in which an acceleration rate of the vehicle and an angular velocity of the vehicle are each less than or equal to a predetermined value.
   (2)

The vehicle control apparatus according to (1), in which
the control unit is configured to determine whether the vehicle is in the steady state or the transient state, based on acceleration rate data and angular velocity data that are obtained by a first sensor, and
the control unit is further configured to set the gain of the fluctuation torque, based on gear stage data obtained by a second sensor.
   (3)

The vehicle control apparatus according to (1) or (2), in which
when the requested torque in the transient state is regenerative torque, the control unit is configured to set the gain of the fluctuation torque in a first gear stage to a first gain, and
when the requested torque in the transient state is power running torque, the control unit is configured to set the gain of the fluctuation torque in the first gear stage to a second gain that is less than the first gain.
   (4)

The vehicle control apparatus according to any one of (1) to (3), in which
the control unit is configured to determine whether it is necessary to add the fluctuation torque to the requested torque, based on a control flag received from an inputting member provided in the vehicle, and
when the control flag indicates that it is necessary to add the fluctuation torque to the requested torque, the control unit is configured to acquire the target torque by adding the fluctuation torque to the requested torque.
   (5)

A vehicle control method, the method being configured to be applied to a vehicle control apparatus configured to control a vehicle that travels by driving a motor, the method including:
acquiring target torque by adding, to requested torque corresponding to an acceleration rate request, fluctuation torque that fluctuates cyclically, and controlling torque of the motor, based on the acquired target torque; and
varying a gain of the fluctuation torque depending on a gear stage when the vehicle is in a transient state, the transient state being different from a steady state in which an acceleration rate of the vehicle and an angular velocity of the vehicle are each less than or equal to a predetermined value.

The control unit 20 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the control unit 20 illustrated in FIG. 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the control unit 20 illustrated in FIG. 1.

1. A vehicle control apparatus configured to control a vehicle that travels by driving a motor, the vehicle control apparatus comprising
a control unit configured to acquire target torque by adding, to requested torque corresponding to an acceleration rate request, fluctuation torque that fluctuates cyclically, and control torque of the motor, based on the acquired target torque, wherein
the control unit is configured to, when the vehicle is in a transient state, vary a gain of the fluctuation torque depending on a gear stage, the transient state being different from a steady state in which an acceleration rate of the vehicle and an angular velocity of the vehicle are each less than or equal to a predetermined value.

2. The vehicle control apparatus according to claim 1, wherein
the control unit is configured to determine whether the vehicle is in the steady state or the transient state, based on acceleration rate data and angular velocity data that are obtained by a first sensor, and
the control unit is further configured to set the gain of the fluctuation torque, based on gear stage data obtained by a second sensor.

3. The vehicle control apparatus according to claim 1, wherein
the control unit is configured to, when the requested torque in the transient state is regenerative torque, set the gain of the fluctuation torque in a first gear stage to a first gain, and
the control unit is configured to, when the requested torque in the transient state is power running torque, set the gain of the fluctuation torque in the first gear stage to a second gain that is less than the first gain.

4. The vehicle control apparatus according to claim 1, wherein
the control unit is configured to determine whether it is necessary to add the fluctuation torque to the requested torque, based on a control flag received from an inputting member provided in the vehicle, and
the control unit is configured to, when the control flag indicates that it is necessary to add the fluctuation torque to the requested torque, acquire the target torque by adding the fluctuation torque to the requested torque.

5. A vehicle control method, the method being configured to be applied to a vehicle control apparatus configured to control a vehicle that travels by driving a motor, the method comprising:
acquiring target torque by adding, to requested torque corresponding to an acceleration rate request, fluctuation torque that fluctuates cyclically, and controlling torque of the motor, based on the acquired target torque; and
varying a gain of the fluctuation torque depending on a gear stage when the vehicle is in a transient state, the transient state being different from a steady state in which an acceleration rate of the vehicle and an angular velocity of the vehicle are each less than or equal to a predetermined value.

6. A vehicle control apparatus configured to control a vehicle that travels by driving a motor, the vehicle control apparatus comprising
circuitry configured to acquire target torque by adding, to requested torque corresponding to an acceleration rate request, fluctuation torque that fluctuates cyclically, and control torque of the motor, based on the acquired target torque, wherein
the circuitry unit is configured to, when the vehicle is in a transient state, vary a gain of the fluctuation torque depending on a gear stage, the transient state being different from a steady state in which an acceleration rate of the vehicle and an angular velocity of the vehicle are each less than or equal to a predetermined value.
